(19) United States
(12) Patent Application Publication
(10) Pub. No.: US 2024/0383022 A1
(43) Pub. Date: Nov. 21, 2024

(54) PROCESSING USED SOLAR MODULE FOR RECYCLING

(71) Applicant: SOLARCYCLE, Inc., Mesa, AZ (US)

(72) Inventors: Pablo RIBEIRO DIAS, Mesa, AZ (US); Vicente SCHAEFFER VIELMO, Mesa, AZ (US); Gustavo DA ROSA CUNHA, Mesa, AZ (US); Robert VINJE, Mesa, AZ (US)

(21) Appl. No.: 18/666,479

(22) Filed: May 16, 2024

Related U.S. Application Data
(60) Provisional application No. 63/503,127, filed on May 18, 2023.

(51) Int. Cl. B09B 3/32; B09B 3/35; B09B 3/40; B09B 3/50; B09B 101/15; B09B 101/50

(52) U.S. Cl. CPC B09B 3/32; B09B 3/40; B09B 3/50; B09B 3/35; B09B 2101/15; B09B 2101/50

(57) ABSTRACT

Glass may be recovered from a used solar module through heating and the application of stress (such as mechanical stress). One or more of ⋅junction box removal, ⋅cable removal, and/or ⋅deframing may result in a used solar module comprising glass adhered to a laminate including polymer and a photovoltaic (PV) material such as crystalline silicon. Heat can be applied via conduction, convection and/or radiation to achieve removal of glass. Applied radiation of specific wavelengths may be absorbed by material(s) of interest (e.g., polymer encapsulant) but not by others (e.g., the glass). Following and/or concurrent with the heating, the module may be subject to stress to allow the glass to detach (e.g., in the form of cullets) from the laminate. One approach may be to bend the glass-laminate combination. This bending effectively creates enough stress for the cullets to detach and separate (e.g., fall under the force of gravity).

### CROSS-REFERENCE TO RELATED APPLICATION

The instant nonprovisional patent application claims priority to U.S. Provisional Patent Application No. 63/503,127, filed May 18, 2023 and incorporated by reference in its entirety herein.

### BACKGROUND

As world population increases, the earth is subjected to escalating environmental stress. One form of stress is manifest in rising global temperatures attributable to the burning of fossil fuels in order to provide energy needs.

Alternative energy sources can provide power, while lessening the carbon dioxide burden on the planet. One important source of alternative energy is solar power.

Solar modules are complex manufactured items. They harness the sun's energy and convert it into a usable energy source for residential, commercial and utility-scale applications. As the climate has been significantly impacted by the use of fossil fuels over the past century, the need for alternative sources of energy like solar has taken on greater importance.

Another form of environmental stress imposed upon the earth, is the accumulation and disposal of waste products from human activity. Accordingly, rather than discarding a solar module at the end of its lifetime, it may be desirable to recycle material(s) from a solar module for reuse and thereby avoid deposition in a landfill.

### SUMMARY

Embodiments recover glass from a used solar module through a combination of heating and the application of stress (such as mechanical stress). In particular, one or more of ⋅junction box removal, ⋅cable removal, and/or ⋅deframing may result in a used solar module comprising glass adhered to a laminate including polymer and a photovoltaic (PV) material such as crystalline silicon. Heat can be applied via conduction, convection and/or radiation to achieve removal of glass. Applied radiation of specific wavelengths may be absorbed by material(s) of interest (e.g., polymer encapsulant) but not by others (e.g., the glass). Following and/or concurrent with the heating, the module may be subject to stress to allow the glass to detach (e.g., in the form of cullets) from the laminate. One approach to the application of stress, may be to bend the glass-laminate combination in one or more different directions. This bending effectively creates enough stress for the cullets to detach and separate (e.g., fall under the force of gravity).

### BRIEF DESCRIPTION OF THE DRAWINGS

FIG. 1 shows a simplified top view of an apparatus according to one embodiment.

FIG. 2 shows a process flow of the embodiment of FIG. 1.

FIG. 2A shows a simplified free body diagram of a glass cullet in the embodiment of FIG. 2.

FIG. 3 shows a simplified top view of an apparatus according to an alternative embodiment.

FIG. 4 shows a process flow of the embodiment of FIG. 3.

FIG. 4A shows a simplified free body diagram of a glass cullet in that embodiment.

FIG. 5 plots transmission spectra for silicon in the NIR (Near Infrared) and MIR ranges.

FIG. 6 shows the transmissivity curves of engineering glasses in the infrared spectrum.

FIG. 7 plots transmissibility in the IR spectrum of ethylene vinyl acetate (EVA) polymer films with different fiber contents.

FIG. 8 shows a side perspective view of an approach portion where the incoming used modules loaded in the horizontal position are transitioned to the vertical position.

FIG. 9 shows a front perspective view of an approach portion where the incoming used modules loaded in the horizontal position are transitioned to the vertical position.

FIG. 10 shows top view of a middle portion of a tool according to the embodiment of FIG. 3.

FIG. 11 shows a top perspective view of the middle portion.

FIG. 12 shows a simplified front perspective view of a tool embodiment in operation.

FIG. 13 shows a front perspective view with the apparatus open.

FIG. 14 shows a simplified cross-section of a solar module.

FIG. 14A shows a simplified plan view of a solar module.

FIGS. 15A-B show simplified views of a bending mechanism according to an alternative embodiment.

FIG. 16 shows a simplified view of an embodiment of a hold down mechanism.

FIG. 17 shows a simplified view of a jaw bending mechanism according to an embodiment.

### DESCRIPTION

Solar modules exist in a variety of types and architectures. Examples of such modules can include but are not limited to:
Monocrystalline Solar Panels (Mono-SI)
Polycrystalline Solar Panels (p-Si)
Amorphous Silicon Solar Panels (A-SI)
Cadmium telluride photovoltaics (CdTe)
Copper indium gallium selenide modules (CIGS)
Copper indium selenide modules (CIS)
Concentrated PV Cell (CVP)
Biohybrid Solar modules
Monofacial modules
Bifacial modules
Modules without encapsulant
Silicon heterojunction solar modules
tunnel oxide passivated contact solar modules (TOPCON)
passivated emitter and rear contact solar modules (PERC)
Tandem-junction Solar Panels
Perovskite-based Solar Panels
Glass-Backsheet Solar Panels
Glass-Glass Solar Panels
Building-Integrated Solar Panels
Polymer-Based Solar Panels.
Solar Roof Tiles.
Solar Roof Shingles

Solar modules can last decades, with some degradation in performance over a module's lifetime. Also, solar modules that have been deployed on residential rooftops and other commercial and utility-scale applications for a number of years, may be decommissioned for a variety of reasons.

For example, (residential, commercial, utility) users of solar panels may desire to exchange their modules for newer, higher performing modules in order to maximize the amount of energy obtained from a solar array.

As more solar modules reach the end of their useful lives and/or are relinquished by their owners, it is desirable to dispose of the panels in an environmentally-friendly and economically-feasible way. Alternatively, it may be desired to refurbish and reuse existing solar modules to prolong their lifetimes and reduce cost.

Once it is determined that a solar module is no longer useful to its owner, e.g.:
the module has reached the end of its current deployment due to non- or underperformance,
the module has been damaged in transit, or
for other (e.g., economic) reasons,
   in order to avoid discarding the module into a landfill, the module may either be recycled or refurbished and reused.

Accordingly, to determine whether a solar module should be recycled or refurbished and reused, embodiments may implement one or more of the following processes, alone or in various combinations and sequences.
cleaning;
inspection to determine reusability;
testing;
remove cabling;
remove frames surrounding the panel and/or junction boxes (either manually, or e.g., using an automated deframing machine).
transparent front layers and potentially other layers (e.g., the backsheet) may be removed using a delamination process.

Remaining layers (of, e.g., a laminate) may be shredded. Shredded materials can be separated using one or more processes in order to extract various possible reusable materials therefrom (e.g., valuable commodity metals such as silicon, silver, and/or copper).

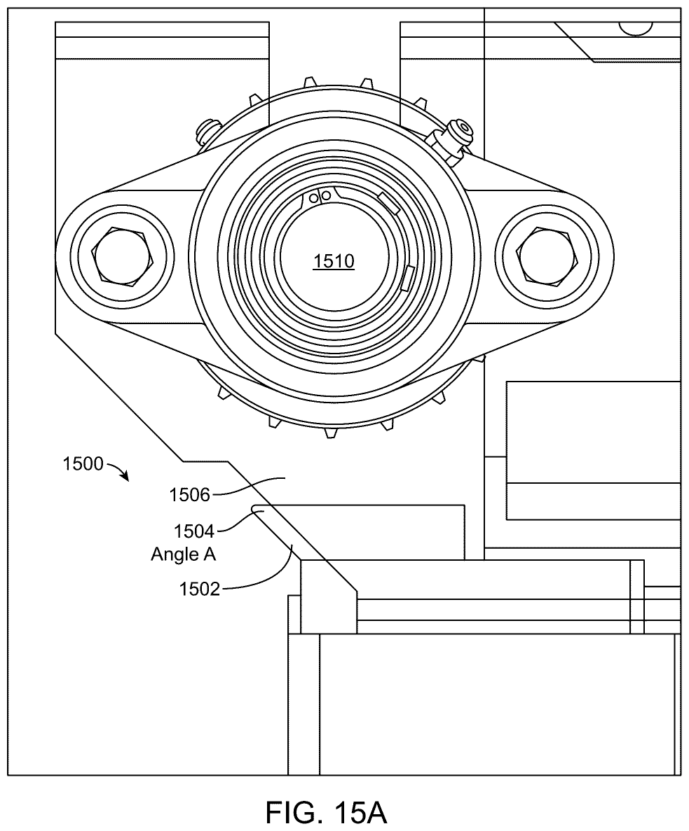

Embodiments relate to various techniques that may be employed, alone or in combination, for the recycling and/or refurbishment of solar modules. FIG. 14 shows a cross-sectional view of a monofacial solar module according to an example.

The PV module 1400 is made of different layers assembled into the structure shown in FIG. 14. These layers of FIG. 14 are not drawn to scale.

The layers of FIG. 14 can be simplified as:
substrate (backsheet) 1402,
back encapsulant 1404, e.g., Ethylene-vinyl acetate (EVA), silicone, Polyvinyl butyral (PVB), IONOMER, polyolefin elastomer (POE)
solar cell 1406 comprising PV material (including, e.g., but not limited to: doped single crystal, polycrystalline, or amorphous silicon, Group III-V materials) and metallization,
front encapsulant 1408,
transparent front cover sheet 1410 (e.g., typically glass).
   This grouping of layers is referred to as a laminate 1412.

It is further noted that bifacial modules also exist. Such bifacial modules may exhibit a structure similar to that of FIG. 14, but have a transparent (e.g., glass) layer instead of a backsheet layer. This allows (e.g., reflected) light to enter the module from the back.

The laminate in FIG. 14 is surrounded by a frame 1414. The frame may comprise a stiff metal such as aluminum. Alternatively, a frame material may be plastic, comprising e.g., polycarbonate.

A junction box 1416 is also part of the module. The junction box may be potted (more common in newer models) or non-potted (more common in older models). In a potted PV junction box, the foils coming out of the solar panel are soldered to the diodes in the junction box, and the junction box is potted or filled with a type of sticky material to allow thermal transfer of heat to keep the solder joint in place and prevent it from falling. Fabrication may take longer but creates a better seal.

In the non-potted PV junction box, a clamping mechanism is used to attach the foil to the wires in the junction box. This can involve a faster assembly, but may not be as robust. A module having a potted junction box may be more amenable to recycling or refurbishment.

FIG. 14A shows a simplified overhead view of the laminate of a solar module, lacking the frame and the top transparent sheet. FIG. 14A shows solar cells including patterned metallization 1418, which may comprise, e.g., a valuable metal such as silver.

Glass may make up a large portion of the overall mass of a solar module. During recycling of a solar module, it may be desirable to selectively remove that glass.

The glass of solar modules may exhibit specific properties desirable for photovoltaic (PV) applications. Such properties can include one or more of:
transmittance (e.g., >91%),
weather resistance,
texture to promote deposition of anti-reflective coating (ARC) and/or adhesion (e.g., of encapsulant, among others).

Recovering glass from a used solar panel for use in recycling, can confer one or more benefits. Such benefits may include but are not limited to:
lower energy requirements,
lower cost
lower carbon footprint in respect to forming glass from raw materials.

Other materials may be present with the glass during a recycling process. Thus, cleaning and/or purification may be performed.

According to embodiments, glass from a used solar module may be recovered through a combination of heating and the application of stress (such as mechanical stress). In particular, one or more of ⋅junction box removal, ⋅cable removal, and/or ⋅deframing may result in a used solar module that comprises glass adhered to a laminate which includes at least polymer and a photovoltaic (PV) material such as crystalline silicon.

In some embodiments, heat can be applied via conduction, convection and/or radiation to achieve removal of glass. In specific embodiments a hot plate can be used on the front side and/or back side of the module.

The used solar module could be placed inside a furnace to achieve heating. Lamps could be used to irradiate specific wavelengths that are absorbed by material(s) of interest (e.g., polymer encapsulant) but not by others (e.g., the glass).

According to some embodiments, the encapsulant of the module could be heated to a temperature of between about 20-200° C., or between about 40-90° C., or between about 60-80° C. This results in a decrease in a force of adhesion of the encapsulant and other components of the used solar module.

Following and/or concurrent with the heating, the module may be subject to stress to allow the glass to detach (e.g., in the form of cullets) from the laminate.

Various types of energy may be applied in order to achieve glass removal according to embodiments. Such energy may take one or more of the following forms:
mechanical (including jets of applied fluids and/or particles)
sonic (including ultrasonic)
electromagnetic
chemical
thermal.

One approach to the application of stress, may be to bend the glass-laminate combination in one or more different directions. This bending effectively creates enough stress for the cullets to detach and separate (e.g., fall under the force of gravity).

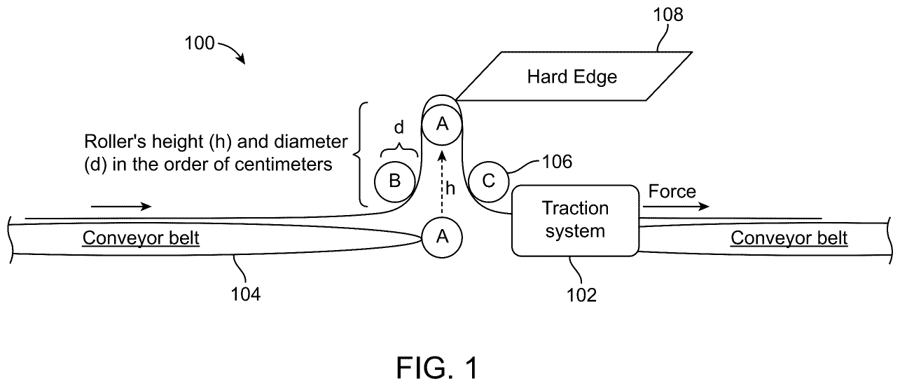

An apparatus 100 according to one embodiment is shown in the simplified top view of FIG. 1. Here, the laminate-glass combination can be pushed (from left to right) using a traction system 102 and conveyors 104. A set of rollers 106 serves to apply mechanical stress. Then, a bulkhead/shield/screen presses against the glass, providing a hard edge 108 to detach glass cullets.

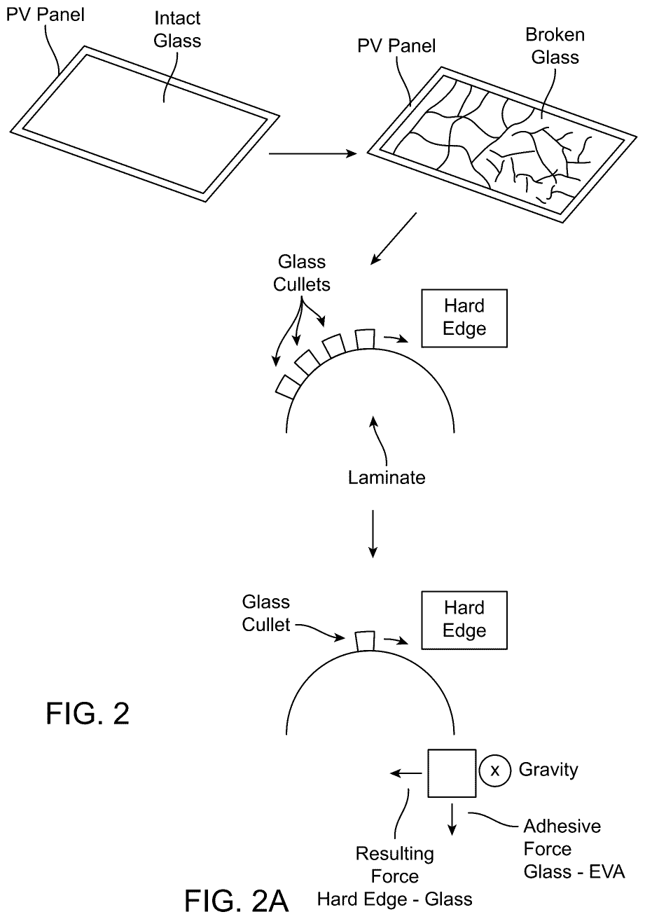

The hard edge of the bulkhead/shield/screen applies stress in a direction substantially normal. FIG. 2 shows a process flow of the embodiment of FIG. 1. FIG. 2A shows a simplified free body diagram of a glass cullet in this embodiment. Here, the edge applies substantially normal force or stress to the cullet.

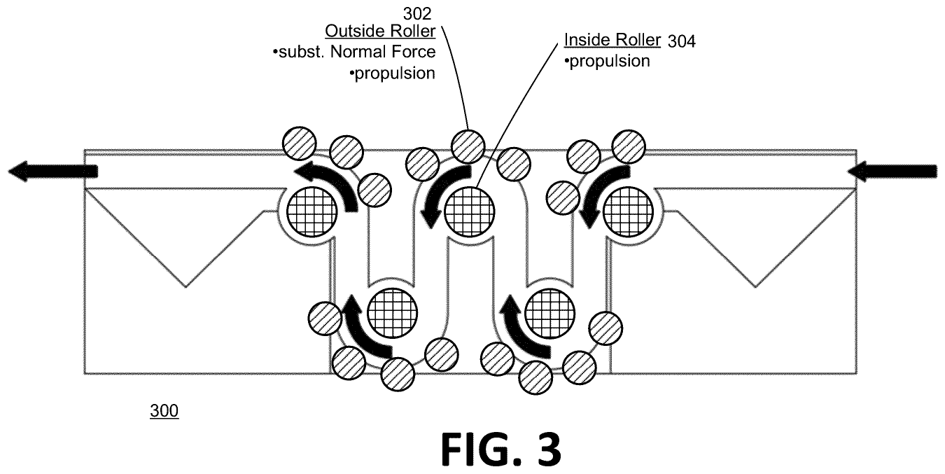

FIG. 3 shows a simplified top view of an apparatus 300 according to an alternative embodiment. This apparatus can be automated to achieve high throughput using a set of outside rollers 302 to apply stress in a direction substantially normal. In combination with rotation of the inside rollers 304, the rotation of the outside rollers also serves to propel the solar module through the device in the direction shown by the arrows (right-to-left). Not all rollers need be driven-some could simply rotate to accommodate movement of the glass/laminate through the device.

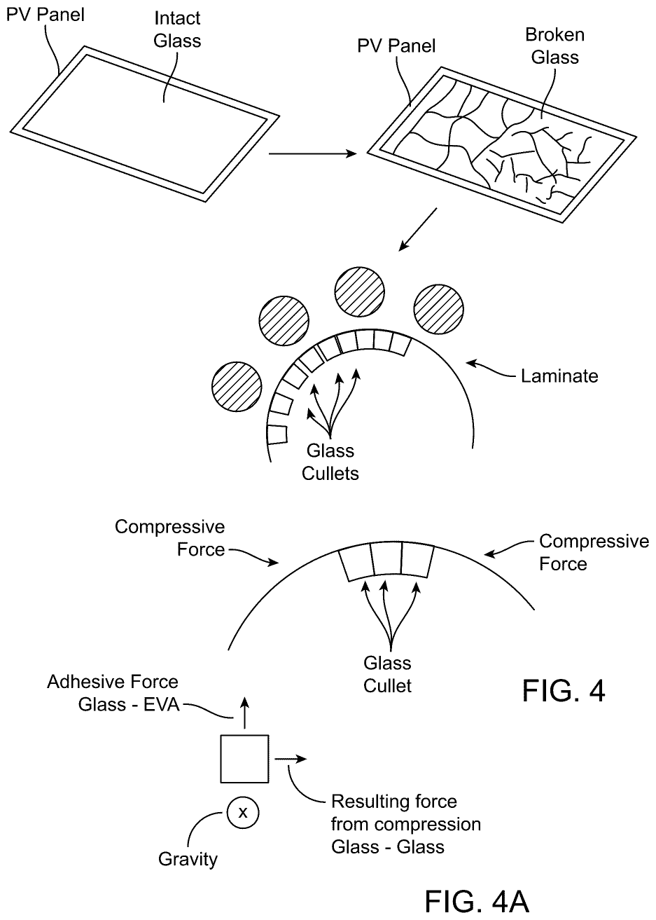

FIG. 4 shows a process flow of the embodiment of FIG. 3. FIG. 4A shows a simplified free body diagram of a glass cullet in that embodiment. Here, compression by the adjacent cullets resulting from bending of the laminate and glass by the outside rollers, produces the resulting substantially normal force. The cullets detach from the laminate and fall away under the influence of gravity.

It is noted that the embodiments of FIGS. 1-4A are not exclusive, and alternative embodiments could combine features. For example, for one side the glass of a bifacial module could be removed by an edge, and the opposite side could be removed by a roller.

In addition to rotating, according to some embodiments the rollers may move back and forth, and/or up and down, in order to provide stress and promote removal of glass. Multiple rollers deployed in sequence can promote removal of glass.

Heating can take place before or in conjunction with the application of energy. Certain approaches may have the plates and rollers heat up and thereby transfer the heat to the laminate.

It is noted that heating can take place under a variety of conditions. For example, heating can result from the application of radiation. The glass and the other materials may exhibit different properties in response to the applied radiation.

Material properties in connection with applied infrared (IR) radiation are now discussed. A 1064 nm optical-fiber pulsed laser is commercially mature and relatively widely available type of near-IR laser.

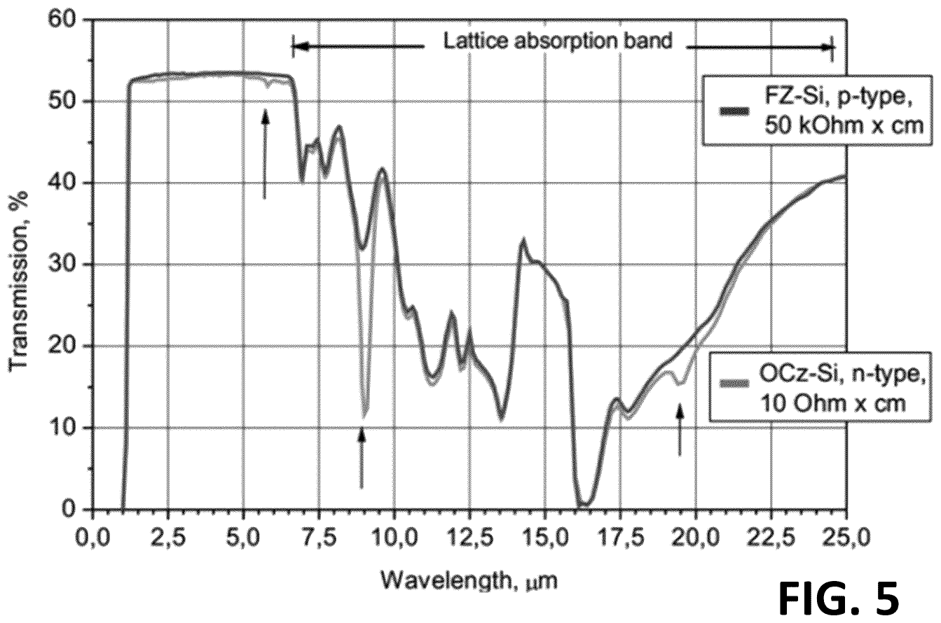

The laminate bearing glass may comprise silicon. FIG. 5 plots transmission spectra for silicon in the NIR (Near Infrared) and MIR ranges. Here, the sample thickness is 5 mm. In general, glass layers in solar modules can be between about 2-5 mm in thickness. The maximum transmissivity of silicon appears to occur from about 1000 nm up to about 6500 nm. This property can be useful to heat silicon in the process of removing glass therefrom.

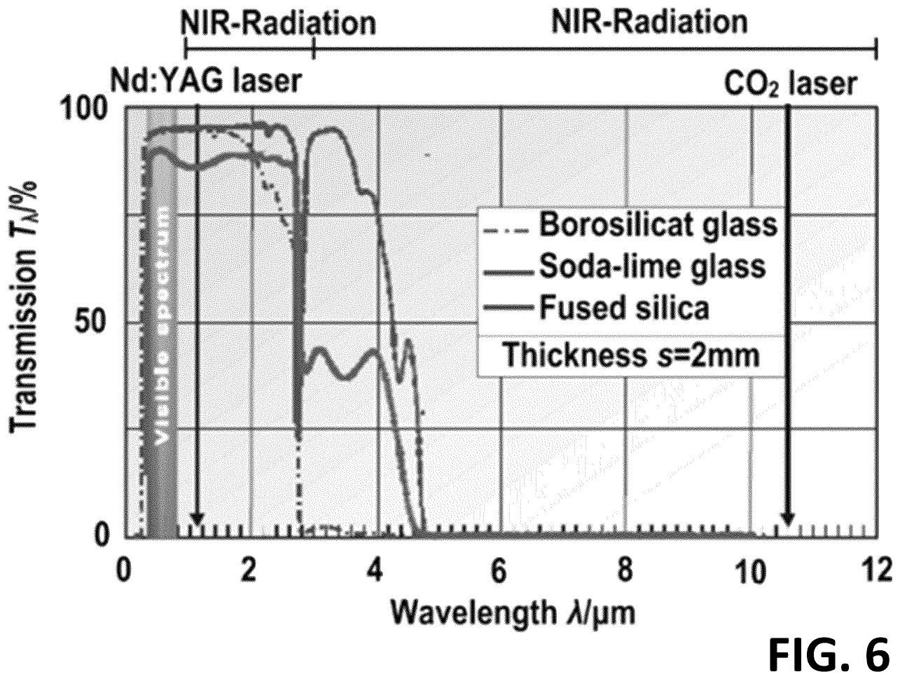

Glass has properties that differ from silicon. FIG. 6 shows the transmissivity curves of engineering glasses in the infrared spectrum. Neodymium-doped yttrium aluminum garnet (Nd: YAG) lasers typically emit light with a wavelength of 1064 nm in the infrared. The CO2 laser produces a beam of infrared light with the principal wavelength bands centering on 9.6 and 10.6 μm. FIG. 6 shows that the highest transmissivities of the engineering glasses occur between about 1000 nm and about 2200 nm.

In some embodiments, applied radiation could be designed to be absorbed by and heat the glass. In certain embodiments applied radiation could be designed to transmit through the glass in order to reach and heat the underlying material.

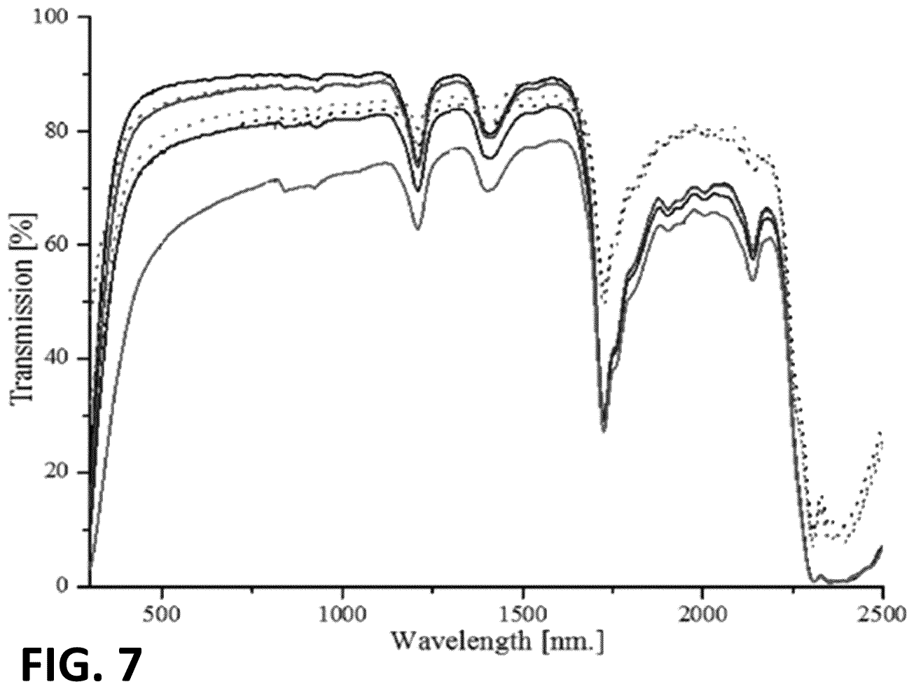

Polymer has properties that differ from silicon or glass. FIG. 7 plots transmissibility in the IR spectrum of ethylene vinyl acetate (EVA) polymer films with different fiber contents. It can be seen in FIG. 7 that the lowest transmissivity or absorption peaks of EVA occur around 2300, 1750, 1300, and 1200 nm. Wavelengths that are absorbed by the EVA may allow the layers of the photovoltaic laminate to be debonded.

In summary, silicon and glass are largely transparent between 1000 and 2200 nm. Some absorption peaks of EVA occur around 1200, 1300, 1750, and 2300 nm. Stronger absorption is present when the light wavelength is shorter than 380 nm or longer than 2200 nm.

While the application of IR radiation is discussed above, embodiments are not limited to the application of any particular wavelength(s). Radiation in the ultraviolet, microwave, or other portions of the spectrum can be applied.

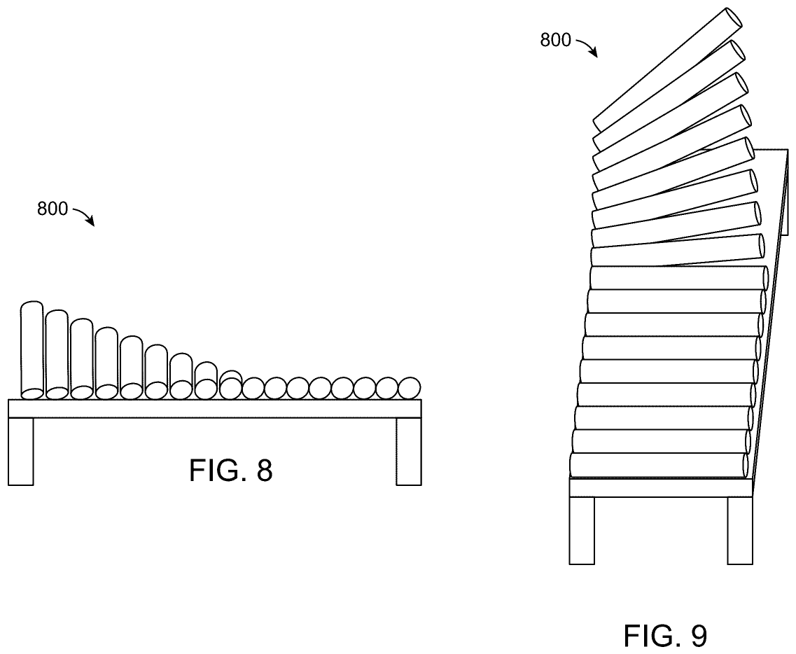

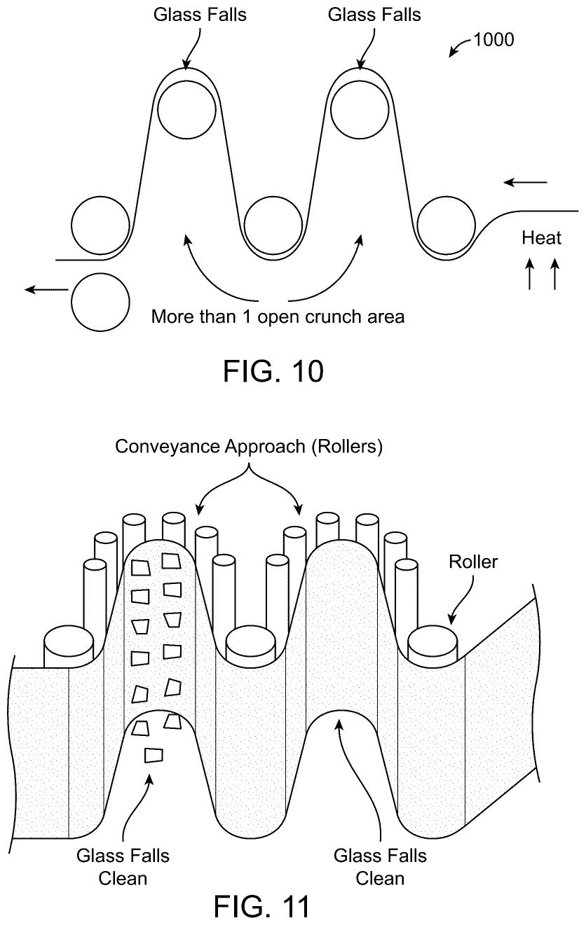

FIGS. 8-13 show different views of embodiments of apparatuses that are configured to remove glass. In particular, FIG. 8 shows a side perspective view, and FIG. 9 shows a front perspective view, of an approach portion 800 where the incoming used modules loaded in the horizontal position are transitioned to the vertical position. This transition may involve rollers on both sides.

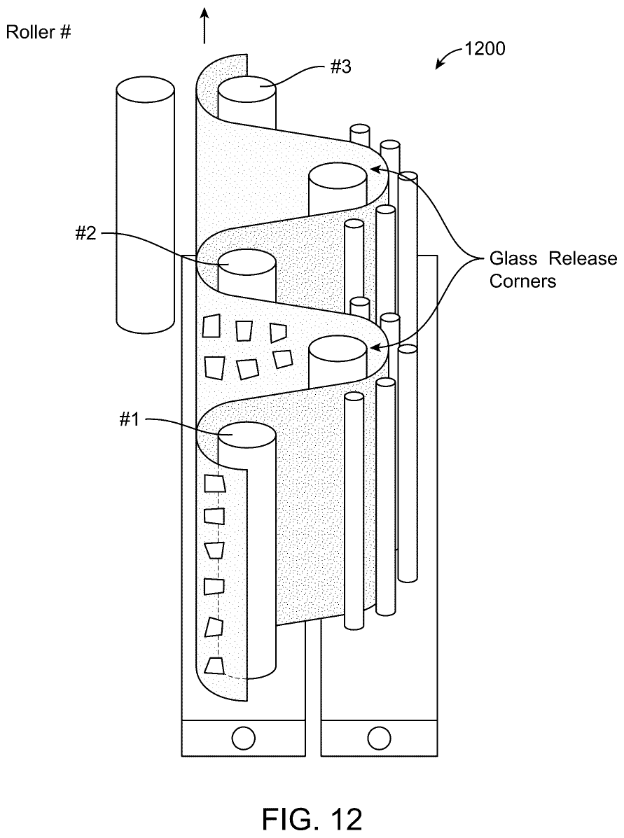

FIG. 10 shows top view of a middle portion 1000 of a tool according to the embodiment of FIG. 3. Outside rollers are omitted for clarity.

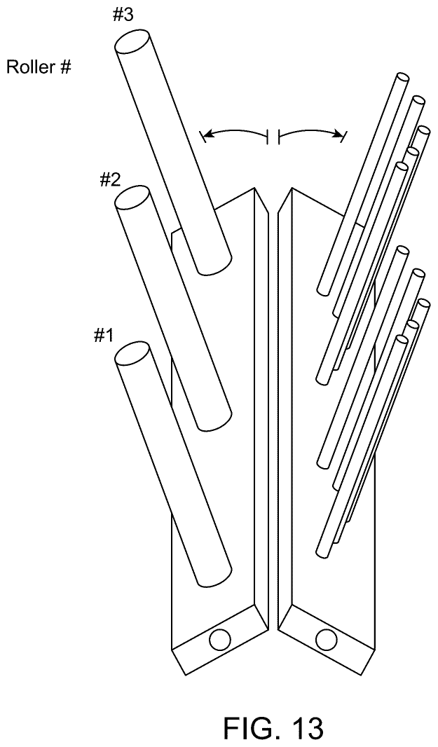

FIG. 11 shows a top perspective view of the middle portion. Here, certain inside rollers are omitted for clarity.

A conveyance approach using rollers both pushes and pulls the modules through the tight corners. Rollers are located on outside corners. Rollers or grippers may or may not be present on certain inside corners, to allow space for the glass cullets to release and fall away (e.g., under the force of gravity). More than one area may be used to receive and collect the falling glass.

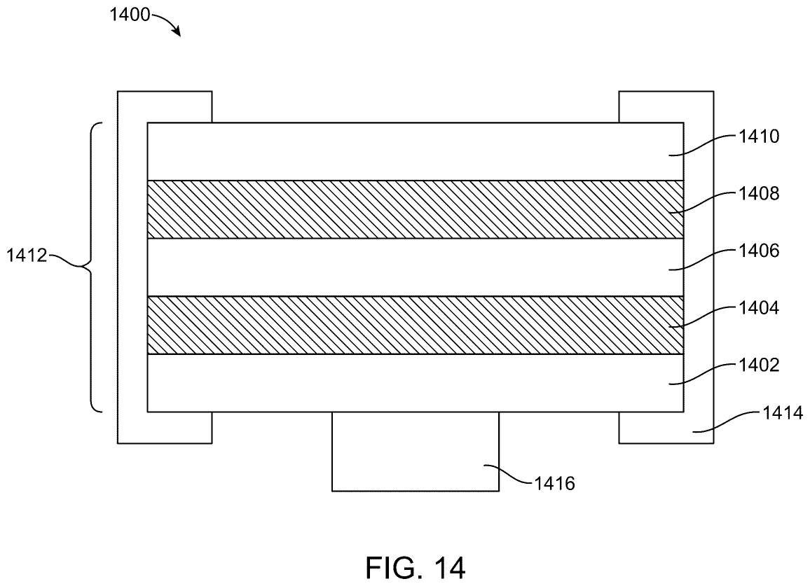

FIG. 12 shows a simplified front perspective view of a tool embodiment in operation. The glass release corners 1200 are shown. Certain outside rollers are omitted for clarity.

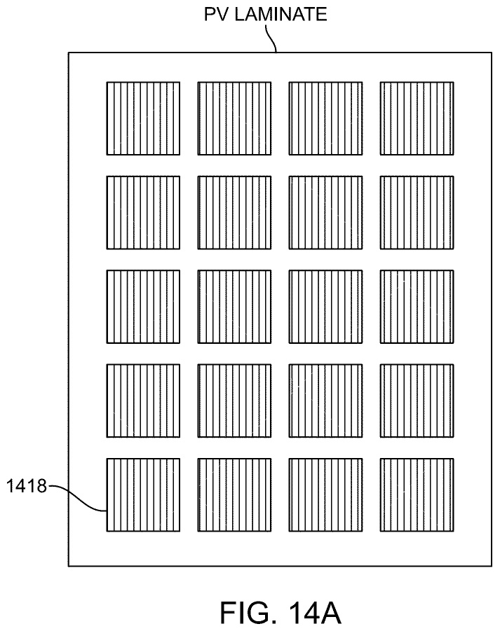

FIG. 13 shows a front perspective view with the apparatus open. In particular, when a jam occurs, the tool can clamshell open because it is hinged.

In operation, the halves of the clamshell may be locked together by a lock and/or hydraulics. In maintenance, the tool can be unlocked and the clamshell opened.

Such an open configuration facilitates one or more of:
removing jammed materials;
cleaning;
roller replacement;
preventative maintenance.

It is noted that embodiments may be utilized to remove glass from a variety of photovoltaic modules. Such modules can be monofacial or bifacial (having glass on opposing sides). Photovoltaic modules from which glass is to be removed, can include crystalline silicon and/or other materials, e.g.:
Group III/V;
Group II/VI including CdTe.

Clause 1A. A method comprising:
receiving a used solar module comprising glass and a laminate comprising a polymer, and a photovoltaic (PV) material;
heating the laminate to reduce a force of adhesion to the glass;
applying stress substantially normal; and
separating glass cullets from the laminate.

Clause 2A. A method as in Clause 1A wherein heating the laminate comprises conduction, irradiation, and/or convection.

Clause 3A. A method as in any of Clauses 1A or 2A wherein heating the laminate comprises applying infrared radiation.

Clause 4A. A method as in Clause 3A wherein infrared radiation is transmitted through the glass.

Clause 5A. A method as in any of Clauses 1A, 2A, 3A, or 4A wherein the stress is applied by an edge.

Clause 6A. A method as in any of Clauses 1A, 2A, 3A, 4A, or 5A wherein the stress is applied by a roller.

Clause 7A. A method as in Clause 6A wherein the roller is heated.

Clause 8A. A method as in any of Clauses 1A, 2A, 3A, 4A, 5A, 6A, or 7A wherein the polymer comprises ethylene vinyl acetate.

Clause 9A. A method as in any of Clauses 1A, 2A, 3A, 4A, 5A, 6A, 7A, or 8A wherein the photovoltaic material comprises silicon.

Clause 10A. A method as in any of Clauses 1A, 2A, 3A, 4A, 5A, 6A, 7A, 8A, or 9A wherein the heating is prior to the application of stress.

Clause 11A. A method as in any of Clauses 1A, 2A, 3A, 4A, 5A, 6A, 7A, 8A, 9A, or 10A wherein the heating is concurrent with the application of stress.

Clause 1B. An apparatus comprising:
an intake configured to receive a laminate comprising photovoltaic material and polymer adhered to glass by an adhesive force;
a heater configured to apply energy to the laminate and reduce a strength of the adhesive force; and
a member configured to apply mechanical stress in a direction substantially normal and remove the glass.

Clause 2B. An apparatus as in Clause 1B wherein the member comprises an edge.

Clause 3B. An apparatus as in any of Clauses 1B or 2B wherein the member comprises a roller.

Clause 4B. An apparatus as in Clause 3B wherein the heater is part of the roller.

Clause 5B. An apparatus as in Clause 3B wherein the roller is further configured to move back and forth to apply the mechanical stress.

Clause 6B. An apparatus as in any of Clauses 1B, 2B, 3B, 4B, or 5B wherein the heater is configured to apply the energy by at least one of conduction, irradiation, and convection.

Clause 7B. An apparatus as in any of Clauses 1B, 2B, 3B, 4B, 5B, or 6B wherein the heater comprises at least one of a lamp, a furnace, or a laser.

Clause 8B. An apparatus as in any of Clauses 1B, 2B, 3B, 4B, 5B, 6B, or 7B wherein radiation from the heater is configured to transmit through the glass and be absorbed by the polymer.

Clause 9B. An apparatus as in Clause 8B wherein the radiation is infrared radiation.

Clause 10B. An apparatus as in any of Clauses 1B, 2B, 3B, 4B, 5B, 6B, 7B, 8B, or 9B wherein the heater is a hot plate.

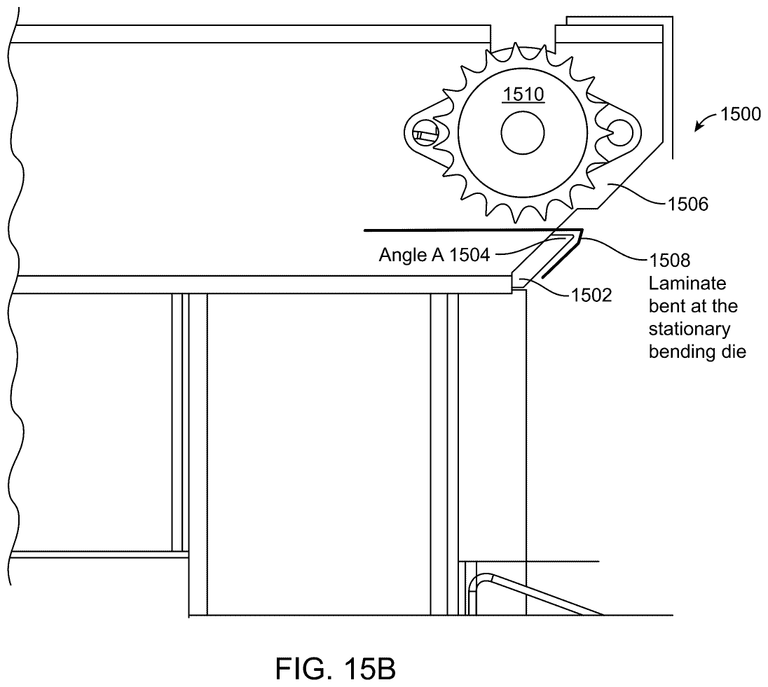

According to an alternative embodiment, the bending equipment may comprise two dies: one moving and one stationary. As shown in the view of FIG. 15A, the stationary bending die 1502 of the bending equipment 1500 is a replaceable wear part that has an Angle A 1504 for the laminate to conform to when it is being bent.

As shown in FIG. 15B, the moving bending die 1506 is a part of the bending mechanism that force bends the laminate 1508 into the stationary bending die. This bending occurs about an Angle A. This creates stress that releases the cullet.

In both of the views of FIGS. 15A-B, the top element 1510 is a sprocket. The sprocket is used for conveyance.

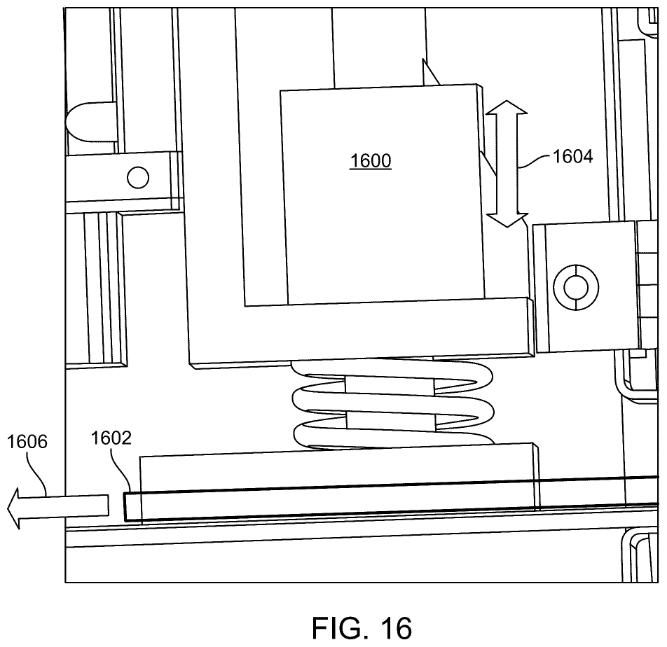

FIG. 16 shows a simplified view of a hold down mechanism 1600. This mechanism can be used to secure the position of the laminate 1602. This securing helps ensure flatness of the laminate when it is being bent against the stationary bending surface.

The hold down mechanism can be actuated in the direction shown by double headed arrow 1604 by a motor, pneumatically, and/or hydraulically. The hold down mechanism is released in order to allow the laminate to be moved in the direction shown by single headed arrow 1606.

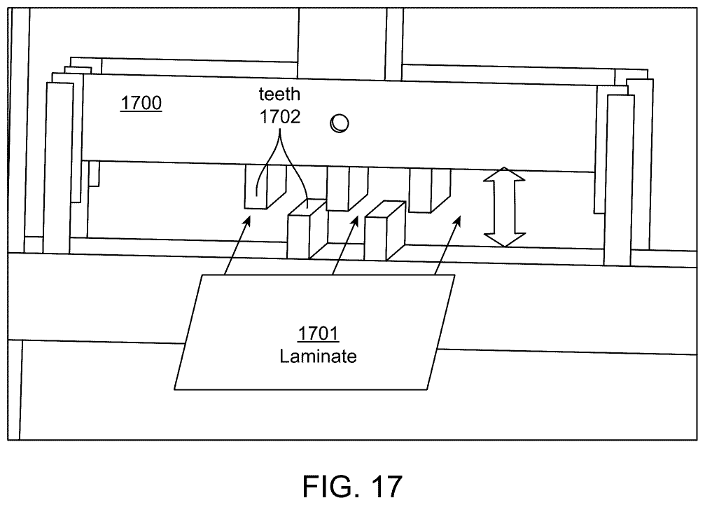

The imposition of mechanical stress to release cullets is not limited to any particular angle or bending mechanism. FIG. 17 shows a simplified view of a jaw bending mechanism 1700.

This jaw bending mechanism presses the laminate 1701 between two sets of teeth 1702 in an enclosed space. Such a configuration allows for narrow bending angles (e.g., of up to 180°), thereby imposing considerable strain on the module that is being processed.

As described above, a solar module that is heated may be subjected to the bending force. One particular apparatus included a hot plate that has the purpose of heating the module. The module can be heated on its entire area as it is being pressed down against the plate. This allows for a homogeneous heating profile.

In some embodiments, a glass side of the laminate would be in contact with the hot plate. In other embodiments, a backsheet of the laminate could be in contact with the hot plate.

It is emphasized that depending upon the particular embodiment, the above approaches may be utilized alone or in various combinations.

What is claimed is:

1. A method comprising:
receiving a used solar module comprising glass and a laminate comprising a polymer, and a photovoltaic (PV) material;
heating the laminate to reduce a force of adhesion to the glass;
applying stress to form cullets in the glass; and
separating the cullets from the laminate.

2. A method as in claim 1 wherein heating the laminate comprises conduction, irradiation, and/or convection.

3. A method as in claim 2 wherein heating the laminate comprises applying infrared radiation.

4. A method as in claim 3 wherein infrared radiation is transmitted through the glass.

5. A method as in claim 1 wherein the stress comprises mechanical stress.

6. A method as in claim 5 wherein the mechanical stress is applied by a roller.

7. A method as in claim 6 wherein the roller is heated.

8. A method as in claim 5 wherein the mechanical stress is substantially normal.

9. A method as in claim 1 wherein the polymer comprises ethylene vinyl acetate.

10. A method as in claim 1 wherein the photovoltaic material comprises silicon.

11. A method as in claim 1 wherein the heating is prior to the application of stress.

12. A method as in claim 1 wherein the heating is concurrent with the application of stress.

13. An apparatus comprising:
an intake configured to receive a laminate comprising photovoltaic material and polymer adhered to glass by an adhesive force;
a heater configured to apply energy to the laminate and reduce a strength of the adhesive force; and
a roller configured to apply mechanical stress to the laminate and remove the glass.

14. An apparatus as in claim 13 wherein the heater is part of the roller.

15. An apparatus as in claim 13 wherein the roller is configured to move to apply the mechanical stress.

16. An apparatus as in claim 13 wherein the heater is configured to apply the energy by at least one of conduction, irradiation, and convection.

17. An apparatus as in claim 13 wherein the heater comprises at least one of a lamp, a furnace, or a laser.

18. An apparatus as in claim 13 wherein radiation from the heater is configured to transmit through the glass and be absorbed by the polymer.

19. An apparatus as in claim 18 wherein the radiation is infrared radiation.

20. An apparatus as in claim 13 wherein the heater is a hot plate.
